(19) United States
(12) Patent Application Publication
(10) Pub. No.: US 2010/0307174 A1
(43) Pub. Date: Dec. 9, 2010

(54) Method and apparatus for controlling certain refrigeration system evaporator fan motors

(76) Inventor: John H. Kernkamp, Citrus Heights, CA (US)

Correspondence Address: John H. Kernkamp, POB 2995, Citrus Heights, CA, 95611, US

(21) Appl. No.: 12/798,795

(22) Filed: Apr. 12, 2010

Related U.S. Application Data
(60) Provisional application No. 61/169,631, filed on Apr. 15, 2009.

(51) Int. Cl. F25D 17/06; F25D 17/04; F25D 21/02; B23P 11/00

(52) U.S. Cl. 62/89; 62/186; 62/140; 29/428

(57) ABSTRACT

A method and device for controlling certain two-speed ECMs (Electronically Commutated Motors) used in refrigeration evaporator coils. Said method and device monitors and responds to the status of the cooling system, causing the ECMs to operate at high speed when the cooling system is actively cooling, and at low speed when the cooling system is idle.

### CROSS-REFERENCE TO RELATED APPLICATION

This application claims priority to U.S. Provisional/ Patent Application No. 61/169,631, filed on Apr. 15, 2009.

### FIELD OF THE INVENTION

The present invention is related to energy saving, particularly energy-saving additions to walk-in and reach-in refrigerators and freezers.

### BACKGROUND OF THE INVENTION

Compressor-associated refrigeration systems function by removing heat from a desired location, thereby cooling that location. For example, in a walk-in type refrigerator, often, more than 30% of the heat found in the location to be cooled is actually generated by fan motors within the refrigeration system itself. A typical walk-in refrigerator may have an evaporator coil fitted with five motors of standard configuration. If these motors are rated at a typical value of 1/20 hp each, their combined heat output would be approximately 11,675 Btu/hr, at normal operating voltage. Clearly, if this amount of system generated heat could be reduced or minimized the efficiency of the overall cooling process would be enhanced and the refrigeration system would be less costly to operate.

### DESCRIPTION OF PRIOR ART

Disclosed in U.S. Pat. No. 5,797,276 is a device for energy conservation in refrigeration chambers. This device claims the use of a triac switch connected to a transformer and discloses a fan control system based on the state of a thermostatic switch within the refrigerated chamber. Neither of these schemes is employed in the subject device.

Disclosed in U.S. Pat. No. 6,397,612 is a device for saving energy in refrigeration systems. This device claims the use of a solid-state switch to control the fan motors, and discloses a fan control system based on a sensor which monitors the state of the refrigerant control valve. Neither of these schemes is employed in the subject device.

Other existing patents addressing the field of the present invention, include

| | | |
|---|---|---|
| 3,877,243 | April 1975 | Kramer |
| 3,959,979 | June 1976 | Kramer |
| 4,167,966 | September 1979 | Freeman |
| 5,488,835 | February 1996 | Howenstein et al. |

None of these patents contain claims which would preclude the current invention.

The foregoing patents reflect the state of the art of which the applicant is aware and are tendered with the view toward discharging applicant's acknowledged duty of candor in disclosing information which may be pertinent in the examination of this application. It is respectfully submitted, however, that none of these patents teach or render obvious, singly or when considered in combination, applicant's claimed invention.

### SUMMARY OF THE INVENTION

An object of the present invention is to provide an evaporator fan controller which controls the speed of certain Electronically-Commutated motors based on the cooling/non-cooling status of a refrigeration system.

Another object of the present invention is to supply an evaporator fan controller that lowers the necessary energy required to operate the refrigeration system by adjusting certain Electronically-Commutated motors associated with the evaporator coils to a lower speed when the system is in non-cooling mode and a higher speed or range of speeds when the system is in cooling mode.

Still another object of the present invention is to relate a method of modifying a new or existing refrigeration system which employs certain Electronically-Commutated motors to produce less heat within a chamber being cooled by the system by following the cooling/non-cooling status of the refrigeration system and regulating the evaporator fan speed appropriately.

Disclosed is an evaporator fan controller that lowers energy use in a heat exchange system. The heat exchange system is usually either a walk-in freezer or a walk-in refrigerator, but may extend to other equivalent systems. Such heat exchange systems are comprised of: a cooled chamber; a compressor, generally outside the cooled chamber; a condenser, outside the cooled chamber; an evaporator, inside the cooled chamber; an evaporator fan or fans, inside the cooled chamber; and refrigerant within refrigerant carrying lines that cycle the refrigerant to the various components in the system.

Additionally, the subject system usually includes a fail-safe operating relay. If a power failure occurs to the energy saving apparatus the evaporator fan motor(s) is (are) directed to operate at the high speed to prevent unwanted icing of the evaporator coils in the cooled chamber.

### BRIEF DESCRIPTION OF THE DRAWINGS

FIG. 1 is a block diagram showing one embodiment of the control apparatus according to the present invention;

### DETAILED DESCRIPTION OF THE PREFERRED EMBODIMENTS

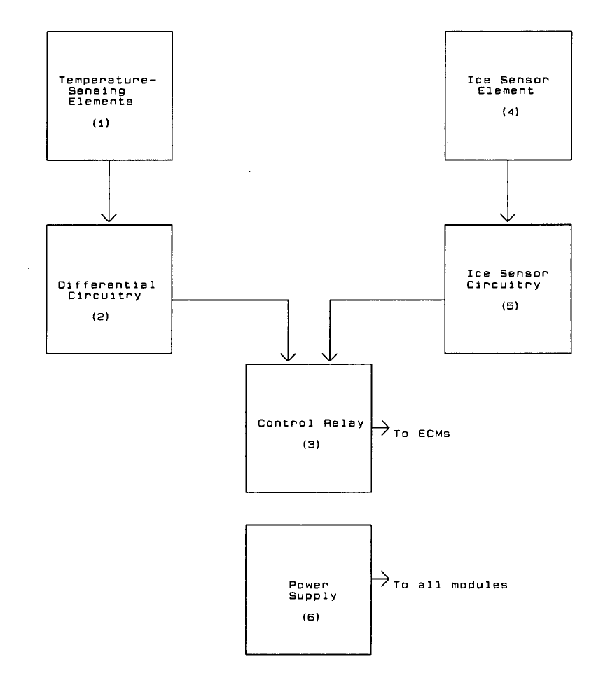

FIG. 1 is a block diagram showing the embodiment thereof. The device is comprised of the following components:
1—Two Temperature-Sensing Elements
2—Temperature-Sensing Circuitry
3—Control Relay
4—Ice Sensor Element
5—Ice Sensor Circuitry
6—Power Supply

The two Temperature-Sensing Elements (1) are resistors whose resistance changes with temperature.

The Temperature-Sensing Circuitry (2) monitors the resistance (temperature) of the two Temperature-Sensing Elements (1) and, depending on the resistance (temperature) of the two Temperature-Sensing Elements (1), activates or de-activates the Control Relay (3).

The Control Relay (3) sends a Control Signal to the ECMs, commanding them to high-speed or low-speed operation.

The Ice Sensor Element (4) is a resistor whose resistance changes with temperature.

The Ice Sensor Circuitry (5) monitors the Ice Sensor Element (4) to determine if there is ice on the evaporator coil. If the Ice Sensor Circuitry (5) senses ice on the coil, it commands the Control Relay (3) to send a control signal to the ECMs, commanding them into high-speed operation.

The Power Supply (6) operates from either 120 or 240 VAC input, and supplies operation power to all of the circuitry and components of the Controller.

The elements necessary for proper functioning of the Controller are the Temperature-Sensing Elements (1), the Temperature-Sensing Circuitry (2), the Control Relay (3) and the Power Supply (6).

The Ice Sensor Element (4) and the Ice Sensor Circuitry (5) could optionally be eliminated.

The embodiment shown in the drawing includes two Temperature-Sensing Elements (1), connected to electronic circuitry (2), which can detect whether or not the two temperature-sensing elements are at the same temperatures.

The Temperature-Sensing Circuitry (2) is connected to the Control Relay (3).

The Ice Sensor Element (4) is connected to the Ice Sensor Circuitry (5), which is connected to the Control Relay (3). If the Ice Sensor Circuit (5) detects that ice is present in the coil, it activates the Control Relay (3), sending a control signal to the ECMs.

The Power Supply (6) is connected to a 120 or 240 VAC power source, and is connected to all circuitry of the Controller, supplying the circuitry with low-voltage operating power.

In operation, the Temperature-sensing Elements (1) are placed in contact with certain portions of a refrigeration system's Evaporator Unit. The placement of these Elements (1) is made with consideration of the concept that, when the refrigeration system is in cooling mode, the two Elements (1) will be at different temperatures, and when the refrigeration system is not cooling (idle), the Temperature-sensing Elements (1) will be at essentially the same temperature.

The Temperature-Sensing Circuitry (2) monitors the resistance (temperature) of the Temperature-Sensing Elements (1), and, as long as there is little or no difference in the temperature of the Temperature-sensing Elements (1), holds the Control Relay (3) in the position to control the ECMs into low-speed mode.

When the temperature of the Temperature-sensing Elements (1) is different by a certain amount, the Temperature-Sensing Circuitry (2) activates the Control Relay (3) to send a signal to the ECMs commanding them into high-speed mode.

The Ice Sensor (4) continuously monitors the refrigeration system's Evaporator Coil to determine if ice is present. If the Ice Sensor Circuitry (5) determines that ice is present on the refrigeration system's Evaporator Coil, it activates the Control Relay (3) to command the ECMs into high-speed operation, and continues to do so until the Ice Sensor Circuitry (5) determines that the ice is dissipated.

A suitably programmed Computer, with appropriate circuitry to accommodate the Temperature-Sensing Elements and the Ice Sensor Element, and with appropriate circuitry to activate a Control Relay could perform the operations of the Controller.

In addition to the normal operation of the Controller, the Computer could also provide recording of the dates and times of high-speed and low-speed operation, and of Ice Sensor activation and de-activation, and provide external notification of problems with the system.

The Controller is manufactured using printed-circuit boards for all of the electronic circuitry (2) and (5), the Control Relay (3), and the Power Supply (6). These printed-circuit boards are mounted inside a case, which case also contains connectors for the various external components. The external components are the Temperature-Sensing Elements (1) and the Ice Sensor Element (4). Connections are also provided for the 120 or 240 VAC input to the Power Supply (6), and for the Control Relay (3) signal to the ECMs. The case is designed for easy installation into existing and new evaporator systems.

The design of the electronic circuitry to effect the operation of the described functions is well known in current technology, and requires no special components or design considerations.

What is claimed is:

1) A control system for two-speed ECMs, capable of commanding the two-speed ECMs into either high-speed or low-speed operation.

2) Said control system, including a sensing system, employing two temperature-sensitive elements to monitor the cooling/idle status of a refrigeration system.

3) Said control system, including a temperature-sensing circuit capable of comparing the resistance of the two temperature-sensitive resistance elements.

4) Said control system, including a control relay, operated by said temperature-sensing circuit.

5) Said control system, including a sensing system employing a single temperature-sensitive resistance element to monitor the refrigeration system's evaporator coil for ice buildup.

6) Said control system, including an electronic circuit capable of determining if said single temperature-sensitive resistance element is detecting ice on the evaporator coil.

7) Said control system, including a power supply, capable of operating from either 120 VAC or 240 VAC input, and capable of supplying operating power to all portions of said control system.

8) An enclosure for said control system, including mounting for printed circuit boards, and connections for input power, said temperature-sensitive resistance elements, and the control signal for the ECMs.

9) A method of mounting said enclosure for said control system onto and into existing evaporators, in retrofit, first installation, or OEM situations.

10) A method for attaching said temperature-sensitive resistance elements to appropriate portions of an evaporator coil.

11) A method for implementing said control system using computer or microprocessor technology.

12) A method for utilizing said computer control system implementation to record times and dates of control of the ECMs to high speed or to low speed.

13) A method for utilizing said computer control system implementation to generate external signals if problems occur with said control system.
